(19) United States
(12) Patent Application Publication
(10) Pub. No.: US 2002/0070186 A1
(43) Pub. Date: Jun. 13, 2002

(54) Mobile crane

(76) Inventors: Uwe Frommelt, Ehingen (DE); Hans-Dieter Willim, Ulm (DE)

Correspondence Address: Rocco S. Barrese, Esq., DILWORTH & BARRESE, LLP, 333 Earle Ovington Blvd., Uniondale, NY, 11553, US

(21) Appl. No.: 09/932,226

(22) Filed: Aug. 17, 2001

(30) Foreign Application Priority Data
Aug. 18, 2000 (DE) 200 14 268.2

(51) Int. Cl. B66C 23/76

(52) U.S. Cl. 212/196

(57) ABSTRACT

A mobile crane has a rotating deck supported at an undercarriage at which a main boom and a derrick counter-boom are supported. A ballast weight is arranged at the arm of the rotating deck projecting in the direction of the counter-boom. The ballast weight is suspended at the counter-boom and can be raised from the rotating deck via a hoist rope in order to allow a swivelling of the unloaded crane without the counter-ballast having to be carried by a carriage following the swivel movement. The counter-boom is provided with luffing devices by which it can be slanted such that the ballast weight can approach the luffing axis of the counter-boom by so much that the overall center of gravity of the superstructure with the boom, counter-boom and set-ups lies inside a circle which maintains a safety distance to the tilting edges of the stabilizer base of the crane.

The invention relates to a mobile crane having a rotating deck supported at the undercarriage preferably provided with crawlers, at which a main boom and a derrick counter-boom are supported, and having a ballast weight arranged at an arm of the rotating deck projecting in the direction of the counter-boom.

Known cranes of this kind usually have a counterweight fixedly fitted to the rotating deck and additionally a derrick ballast which consists of a ballast weight suspended via ropes at the counter-boom. If the load weight suspended at the main boom is missing in such a derrick crane, the derrick ballast must be set down on the ground to prevent a backward tilt. If a swivelling of the unloaded derrick crane should be made possible, the ballast weight must be carried by a carriage so that it can follow a swivel movement.

It is the object of the invention to provide a crane of the kind first mentioned which allows a swivelling of the unloaded crane without the counter-ballast having to be carried by a carriage following the swivel movement.

This object is solved in accordance with the invention in a crane of the kind first stated by the ballast weight being suspended at the counter-boom by a hoist rope and by it being able to be raised off the rotating deck or the ground and by the counter-boom being provided with luffing devices by which it can be slanted such that the ballast weight can approach the luffing axis of the counter-boom by so much that the overall centre of gravity of the superstructure with the boom, counter-boom and set-ups lies inside a circle which maintains a safety distance to the tilting edges of the stabiliser base of the crane.

In the crane of the invention, the rotating deck ballast is combined with the derrick ballast to form one single ballast weight which can be moved towards the axis of rotation of the rotating deck by so much with an unloaded crane that it can be placed on this or on a projecting arm connected to this. If required, the ballast placed on the rotating deck can again be raised via a hoist rope of the counter-boom and swivelled in the desired manner to balance the crane after an appropriately present interlock is released.

If a sufficiently large rear swivel area is available, a load with a substantially reduced ballast weight can be lifted with the main boom, whereby the required transport effort for the ballast weight is reduced.

In the event of obstacles in the rear swivel area, the ballast can be pulled vertically upwards so that obstacles can be passed over.

With the crane of the invention, a very large ballast can be fitted to or set down on the rotating deck which rests on the rotating deck in normal operation. If, however, the load moment is high, then the ballast is raised out of its latch at the rotating deck via a winch in the derrick counter-boom and swivelled so far to the back until the load moment and the counter-moment are approximately the same.

The safety distance appropriately corresponds to a radius of the circle which is 25% smaller than the lowest distance of a tilting edge of the stabiliser base to the axis of rotation of the rotating deck.

To allow the ballast weight to be set on the rotating deck and to be raised from this via the hoist winch of the derrick counter-boom, the ballast weight appropriately consists of two stacks or towers which enclose the projecting arm of the rotating deck between them and are supported on this via a carrier connecting the towers.

The crane according to the invention can also be operated in such a manner that the ballast weight is not set on the rotating deck but is raised from the ground and is suspended in a freely floating manner.

An embodiment of the invention is explained in more detail below with reference to the drawing, in which are shown:

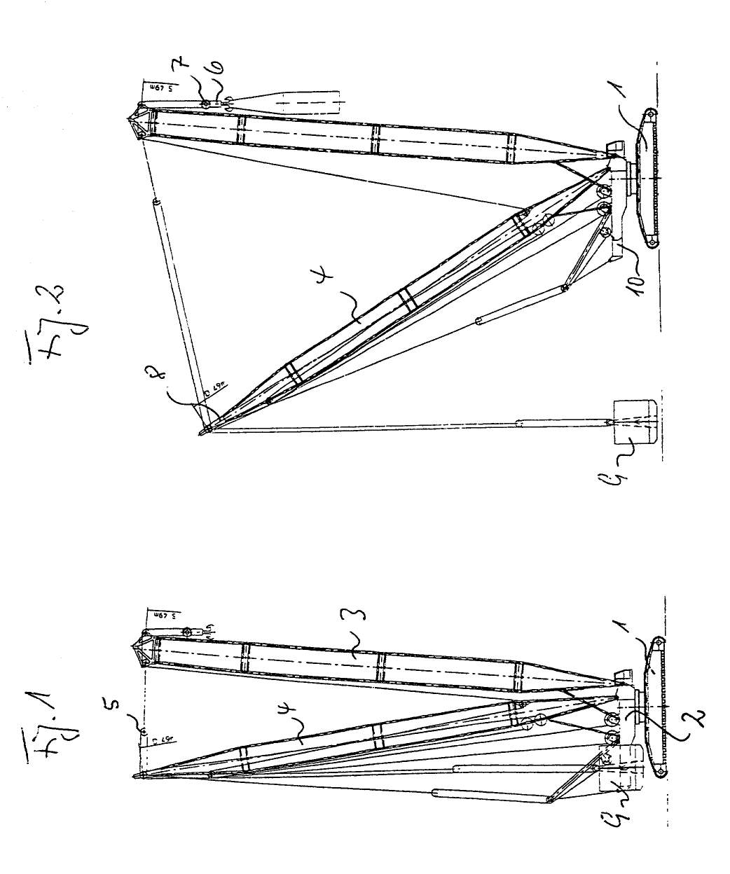

FIG. 1 a derrick crane in a state in which the counter-boom is set so steep that via this a ballast weight can be set on the rotating deck and can be raised from it; and

FIG. 2 the crane of FIG. 1 in a state in which the counter-boom is luffed into a position in which the counterweight has such a large radius from the axis of rotation of the rotating deck that it can balance a great load suspended at the main boom.

A derrick crane is visible from FIGS. 1 and 2 having an undercarriage 1 which is provided with crawlers. The main boom 3 and the derrick counter-boom 4 are supported in the usual manner at the rotating deck 2 rotatably supported on the undercarriage 1. Usual devices are provided for the luffing of the main boom 3 and the counter-boom 4. The head parts of the main boom 3 and of the counter-boom 4 are anchored with respect to one another in a usual manner by an adjustment block 5. The main boom 3, which can consist in the form shown of a latticed mast or also of a telescopic boom, is provided in the usual manner with a lower block 7 carrying a load hook 6. The drive for the hoist rope is of a known type and is not described in any more detail.

A hoist rope, at whose lower block a ballast weight 9 is suspended, runs in a usual manner over return pulleys of the head part 8 of the counter-boom 4. The ballast weight 9 consists of two side stacks or towers which are connected to one another in bridge-like form by a cross member such that the ballast weight 9 can be placed onto an arm 10 of the rotating deck projected backwards when the counter-booms 4 are slanted, as is visible from FIG. 1.

The undercarriage 1 can additionally be supported by stabilisers (not shown). The ballast weight can be set down within the stabiliser base of the crane and then taken up by the hoist block of the counter-boom 4 for the receiving of the ballast weight.

The crane is conceived such that the ballast weight 1 can be swivelled so near to the axis of rotation of the superstructure when the counter-boom is slanted that the overall centre of gravity of the superstructure 1 with the boom, counter-boom, ballast weight and set-ups is located within a circle which still maintains a safety distance to the tilting edges of the stabiliser base of the crane.

1. A mobile crane,
comprising a rotating deck supported at the undercarriage preferably provided with crawlers, at which a main boom and a derrick counter-boom are supported; and
comprising a ballast weight arranged at an arm of the rotating deck projecting in the direction of the counter-boom,
characterised in that the ballast weight is suspended at the counter-boom and can be raised from the rotating deck or the ground via a hoist rope; and
in that the counter-boom is provided with luffing devices by which it can be slanted such that the ballast weight can approach the luffing axis of the counter-boom by so much that the overall centre of gravity of the superstructure with the boom, counter-boom and set-ups lies inside a circle which maintains a safety distance to the tilting edges of the stabiliser base of the crane.

2. A crane in accordance with claim 1, wherein the safety distance corresponds to a radius of the circle which is 25% smaller than the lowest distance of a tilting edge of the stabiliser base to the axis of rotation of the rotating deck.

3. A crane in accordance with either of claims 1 or 2, wherein the ballast weight consists of two stacks or towers which enclose the projecting arm of the rotating deck between them and which are supported on this via a carrier connecting the towers.
